(19) United States
(12) Patent Application Publication
(10) Pub. No.: US 2007/0214103 A1
(43) Pub. Date: Sep. 13, 2007

(54) System and method for providing content over a communications network

(75) Inventor: Orestis Manthoulis, Sausalito, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/372,802

(22) Filed: Mar. 10, 2006

(51) Int. Cl. G06F 17/30

(52) U.S. Cl. 707/1

(57) ABSTRACT

The present disclosure provides a system, method, and computer programs for providing content over a communications network. The method includes providing to a device a first list of items that corresponds to content stored in a first database as a master library; storing in a second database at the network a second list of items selected from the first set of items corresponding a customer identifier in a network database as a personal library; retrieving content from the first database corresponding to an item selected from the second list of items; and providing the retrieved content to a user device over the communications network for display on a television set.

### BACKGROUND OF THE DISCLOSURE

1. Field of the Disclosure

The present disclosure relates generally to the provision of content over a television network.

2. Background

Television services provided over a television network, such as an Internet Protocol Television (IPTV) network, cable network or satellite network, include various content, such as content over multiple channels, Video-on-Demand (VoD), interactive video games, music and other audio content, data from the Internet, etc. to customers or users over a broadband connection. The broadband connection typically terminates at a Set Top Box (STB) located at a customer premise either directly or via a customer gateway, such as a Digital Subscriber Line (DSL) modem. The STB may be coupled to a television set as well as to additional devices, such as a Digital Video Recorder (DVR).

Currently, most of the content is provided via a main television guide that is displayed on the television set. Customers can create personal favorites from the guide and store them on the STB. However, such methods offer limited flexibility in creating personal libraries and choosing content from the vast number of items that can be made available. Thus, there is a need for providing an improved system and method for customers to create personalized libraries and obtain the corresponding content for viewing on user devices.

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals, wherein:

FIG. 1 shows a functional diagram of a network for providing television services according to one embodiment of the present disclosure;

FIG. 2 illustrates a series of screenshots displaying content available from a main library for creating personalized libraries according to one embodiment of the present disclosure;

FIG. 3 illustrates a screenshot showing an exemplary personal library created by a hypothetical customer;

FIG. 4 is a flowchart showing a method according to one embodiment of the present disclosure; and

FIG. 5 is a diagrammatic representation of a machine in the form of a computer system within which a set of instructions, when executed, may cause the machine to perform any one or more of the methodologies discussed herein.

### DETAILED DESCRIPTION OF THE DISCLOSURE

In view of the above, the present disclosure through one or more of its various aspects and/or embodiments is presented to provide one or more advantages, such as those noted below.

The present disclosure provides a system, method and computer programs for providing content over a communications network. In one aspect, the disclosure provides a computer-readable medium that is accessible to a processor for executing instructions contained in a computer program, wherein the computer program includes instructions to provide to a user device a first list of items that corresponds to content stored in a first database associated with a master library; instructions to store in a second database at the communications network a second list of items that is selected from the first list as a personal library corresponding to a customer identifier; instructions to retrieve content from the first database that corresponds to an item selected from the second list; and instructions to provide the retrieved content to a user device over the communications network for display on a television set.

In one aspect, the user device may be a set-top-box (STB) associated with the user identifier and the first and second lists are stored in one or more network databases. In another aspect, the user device may be an STB, a computer or wireless device, such as PDA, cell phone, etc. In another aspect, the computer program may further include instructions to provide attributes corresponding to the first or second lists of items to the user device; instructions to receive a selection of an attribute from the presented attributes; instructions to search the first database for other content having the selected attribute; and instructions to provide a third list that corresponds to the other content. The presented attributes may include artist, producer, director, author, language, subject matter, file, document, etc.

In another aspect, the disclosure describes a method for providing television services which includes: providing to a user device a first set of items that correspond to content stored in a first database in response to a first input; storing in a second database at a network server a second set of items selected from the first set of items in response to a second input; retrieving content from the first database corresponding to an item selected from the second set of items in response to a third input; and providing the retrieved content to a user device for display on a television set.

In another aspect, the disclosure provides a system for use in providing content that includes a first database to store content corresponding to a first library; a second database to store a list of items from the first library corresponding to a user identifier; a server having access to a computer program, the server utilizing the first database and the second database to execute instructions contained in the computer program that include: instructions to provide a first list corresponding to the contents of the first library to a user device; instructions to store a second list selected from the first list as a personal library in response to a user selection; instructions to store the second library in the second database; and instructions to provide content relating to an item selected from the personal library to a user device for display on a user device, such as a computer display, cell phone, PDA, television set, etc.

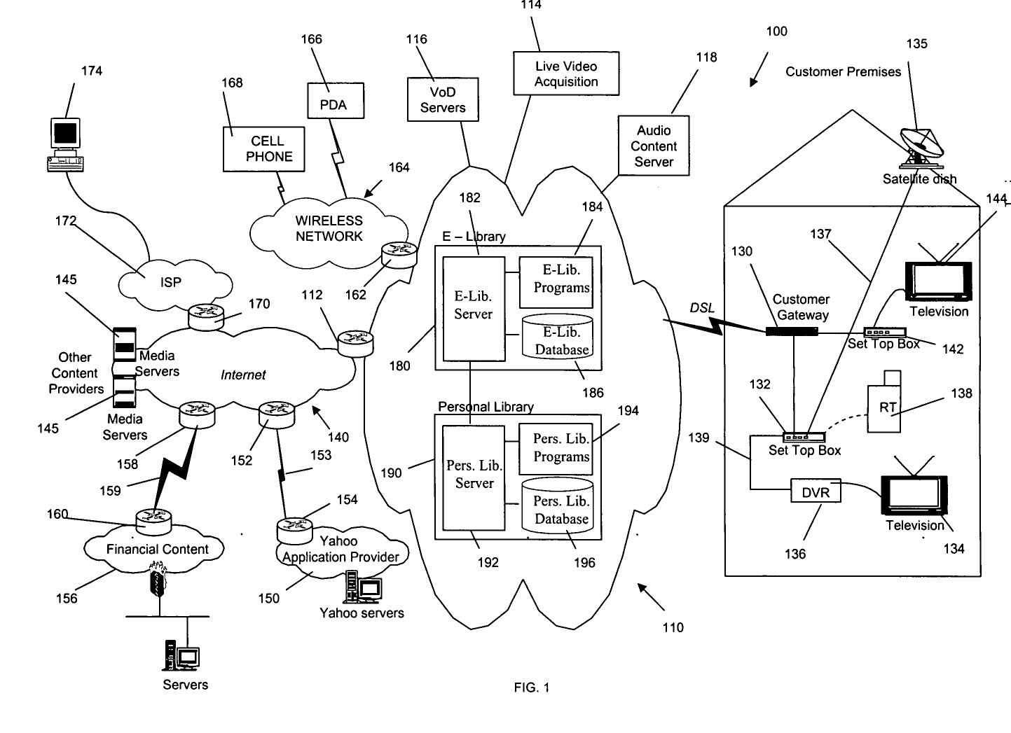

FIG. 1 shows an exemplary high-level functional diagram of a network 100 for providing television services according to one embodiment of the present disclosure. The network 100 is shown to include a backbone 110 that may be coupled to the Internet 140 via one or more routers, such as a router 112. The backbone may provide one of IPTV services, cable television service, and satellite television service to customers, as well as content available through the Internet. Such content includes video, audio and data content. The backbone also may include a variety of servers, routers and transport links for obtaining and processing content. The backbone 110 is shown coupled to a system or element of a live television content provider 114 for live video acquisition that may include multiple television channels, such as are commonly delivered over television networks. The backbone 110 also is shown to include Video-on-Demand (VoD) servers 116 that provide Video-on-Demand. Such servers include associated databases (not shown) that store a variety of video content, such as movies, shows, etc. that may be delivered to customers upon request. The backbone also is shown coupled to audio content servers 118 that provide content such as music, audio tapes, etc. The VoD servers and audio content servers may be located within or outside the backbone 110. The backbone 110 is further shown coupled via a Digital Subscriber Lines (DSLs) to a customer gateway, such as a DSL modem 130, which may be coupled to one or more set-top-boxes (STBs), such as STB 132 and STB 142 that are connected to television (TV) sets 134 and 144 respectively. The DSL line may be wires, such as copper wires, optical fibers, etc. DSL services are suitable for providing IPTV services. Alternatively, the backbone network may couple via a satellite network to satellite dish 135 located at the customer location, which transmits content to the customer devices via a link 137. Alternatively, the backbone 110 may provide content via a cable, such as coaxial cable or any other suitable link. The STBs may act as control interfaces for the respective TV sets and may be accessed by a remote control device, such as remote control 138. In addition, a recording device, such as Digital Video Recorder (DVR) 136 may be connected to an STB, such as STB 132, for recording content. The recording device 136 may be a separate device from the STB and connected thereto via a physical link or may be a module integrated into the STB. Also, the STB and/or recording device functions may be integrated into the television set.

The backbone 110 is further shown coupled to a number of content providers over the Internet 140. For example, the backbone 110 is shown coupled to an Internet service provider (such as “Yahoo” Application provider) 150 via routers 152 and 154, and link 153; and a financial content provider 156 via routers 158 and 160 and link 159 that may provide a financial service, such as customer investment portfolio information and/or enable a customer to order products and services from one or more vendors via the STB 132. Similarly, the backbone 110 may be coupled to or have access to any other partner content provider (generally designated by numeral 145), such as an interactive service that enables a customer to play games against other players via a television, and a gaming service that enables a customer to bet online and settle accounts. The backbone is further shown coupled to a customer computer 174 over the Internet 140 and a service provider 172 via router 170. Additionally, the backbone is coupled to wireless devices such as PDA 166 and cell phone 168 via a wireless network 164 and router 162.

Still referring to FIG. 1, the backbone 110 is further shown to include an E-Library system 180 and a Personal Library system 190. The E-Library system includes a server 182, database 186 and associated computer programs 184. Similarly, the Personal Library system 190 may include a server 192, database 196 and computer programs 194. In one aspect, the E-Library system 180 may store in the database 186 content corresponding to a Main Library (i.e. the E-Library), which may be organized in any suitable manner, such as by content type (video, audio, data), movies, videos-on-demand, interactive games, sports, financial, books, music, etc. Such data may be further organized by subcategories, such as by ratings, authors, subject matter, directors, etc. The system 180 may also retrieve content from any other source, such as VoD servers 116, live content providers 114, over the Internet, etc. and store the retrieved data in the database 186 and transmit to customers. The system 180, in another aspect, may enable other servers or systems in the backbone network to directly provide selected content to customers.

The database 186 and/or 196 may store customer information including identity of the customers, personal identification numbers (PIN), identifier corresponding to each STB at customer premises, physical address, Internet Protocol address, billing information, telephone numbers, services subscribed by the customers, etc. Any other database may also be used to store such information. Thus, in one aspect, each customer or subscriber may have a unique identifier that is stored in a network database.

Any customer who has established an account with the service provider, thus, may access available library contents applicable to the customer account. For example, a customer may log in from a computer 174 via the Internet, use a cellular telephone 168 or PDA 166, or activate STB 132 to obtain a portal that displays a main or first list of items available content from the E-Library. The customer then may select items from the main list to form lists corresponding to one or more personal libraries, which are stored as a main or first list of items for personal libraries in the Personal Library database 196. When a customer logs in from an STB, the system verifies or authenticates the customer account and sends menu (index or list) of the available content to the STB for display on a television set. In one aspect, this may not require inputting a PIN number unless a parental control feature or another restriction is activated. The system may ask for a PIN number when logged in via a wireless device or the Internet. In that event, the system sends the list of available content over the Internet or the wireless network.

When a customer wishes to receive content corresponding to an item selected from the Personal Library, the server 192 receives the selection, verifies the identification and communicates with the system 180 to provide the selected content to the customer device for display. In addition, the user may utilize any remote device to create or update the Personal Library even while watching a selected content. Additionally, customers may create personal sub-libraries corresponding to sub-accounts or PIN numbers, each of which may be stored and accessed from the personal library system at the network. If a selected item is associated with a charge, such as a charge for a VoD, such items in the personal library may be listed under a separate category or may be identified with a marker, such as a specific color, asterisk, or any other suitable indication. Downloading of such content may require the customer to enter an identifier, which may be a PIN. Additionally, any item on the personal library may be marked as requiring permission, such as entry of a PIN. Thus, a customer or user may create and update personal lists from any suitable device remotely and receive content for any item from such a list at any suitable device, including a computer, PDA, cell phone, and STB.

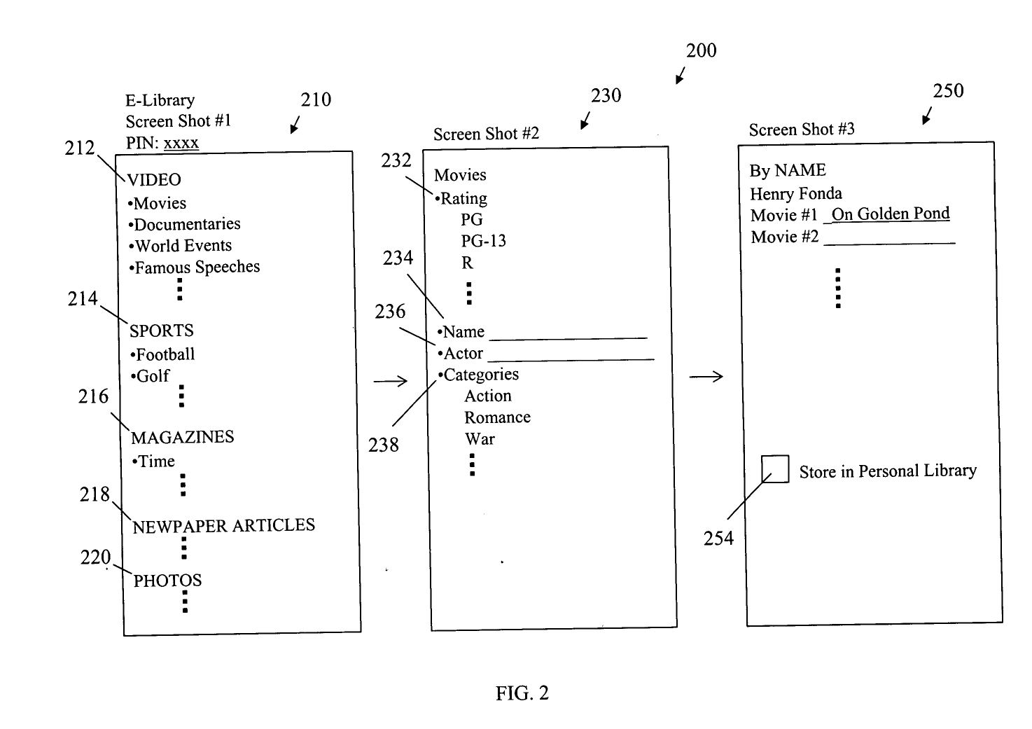

FIG. 2 shows a series of exemplary screenshots 200 that may be made available to customer devices for creating and updating personal libraries, which devices, as noted earlier, may include STB, computer, PDA, cell phone, etc. Upon receiving a customer identifier, such as an input from a remote control associated with an STB, a computer via the Internet, or a PDA over a wireless network, the backbone server provides a portal or screenshot such as screenshot No. 1 (210) to the customer device. The screenshot in essence makes available to the customer a menu, list, or index of content that corresponds to the E-Library associated with system 180 (see FIG. 1). The exemplary screenshot 210 shows certain exemplary categories of available content from the main library, such as video 212, sports 214, magazines 216, newspaper articles 218, photos 220, etc. It will be obvious that only a few categories are shown from the possible available categories. Within each category, subcategories may also be shown. For example under video, subcategories of movies, documentaries, world events, famous speeches, etc. are shown. Similarly, subcategories may be listed under each of the other categories. For example, football, golf, etc. under sports 214, Time magazine under magazines 216 etc. A customer then may click on any of the items listed in screenshot No. 1 (210) and obtain further details. For example, a click on the movies on screenshot No. 1 may provide screenshot No. 2 (230) that provides subcategories for the available movies. Screenshot No. 1 (230) shows that selection for the movies may be made based on ratings 232 (such as PG, PG 13, R, etc.), or from movie categories 238, such as action movies, romance movies, war movies, etc.

Additionally, customers may be provided a space to input certain categories of their own or specify an attribute of a desired content, such as the name of a movie 234, name of an actor 236 or any other attribute. The customer on the screenshot No. 2 may then select a subcategory or specify an attribute, such a name of an actor, such as “Henry Fonda.” If a customer inputs an attribute, such as, Henry Fonda, then system 180 (FIG. 1) may search for movies that feature Henry Fonda and are available to the system (e.g. stored in database 186) or available from other sources, such as VoD servers 116 etc., and provide a screenshot, such as screenshot No. 3 (250). The customer then may click on any one or more of the presented selections and request that the selections be stored in customer's Personal Library by for example, clicking in box 254. The selected items are then stored in a network database as the Personal Library of the customer corresponding to the customer identifier. Thus, in one aspect, the system shown in FIG. 1 and FIG. 2 enables a customer to navigate through the available content to make selections and to store the selected items in a personal library at the network database 194, which may be within the backbone of the network.

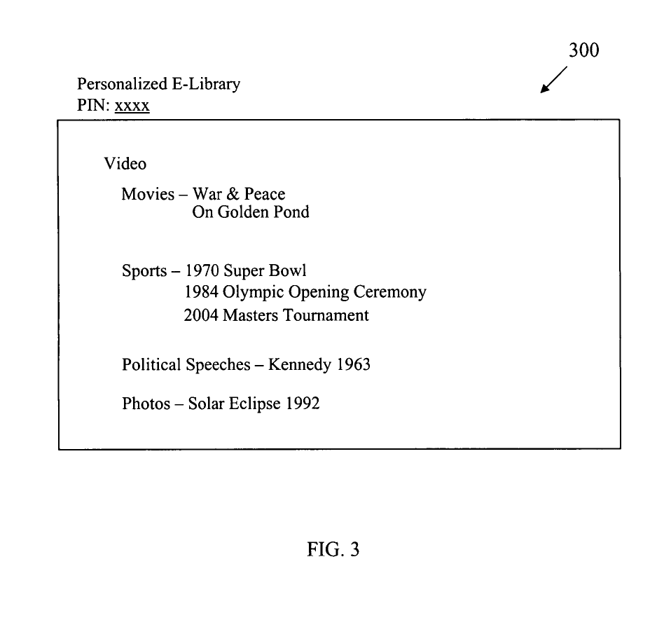

FIG. 3 depicts a screenshot 300 that shows an exemplary personal library stored at the network server 190 for a selected customer that corresponds to a customer identifier “PIN xxxx.” Screenshot 300 shows that a particular customer's personal library includes certain movies, sports events, speeches, and photos. When a customer inputs the identifier, the system 190 makes the personal library available to the customer device. The customer then can click on any of the items in the personal library and receive for viewing the items selected from the personal library. As noted earlier, the customer also may modify the personal library from any remote device.

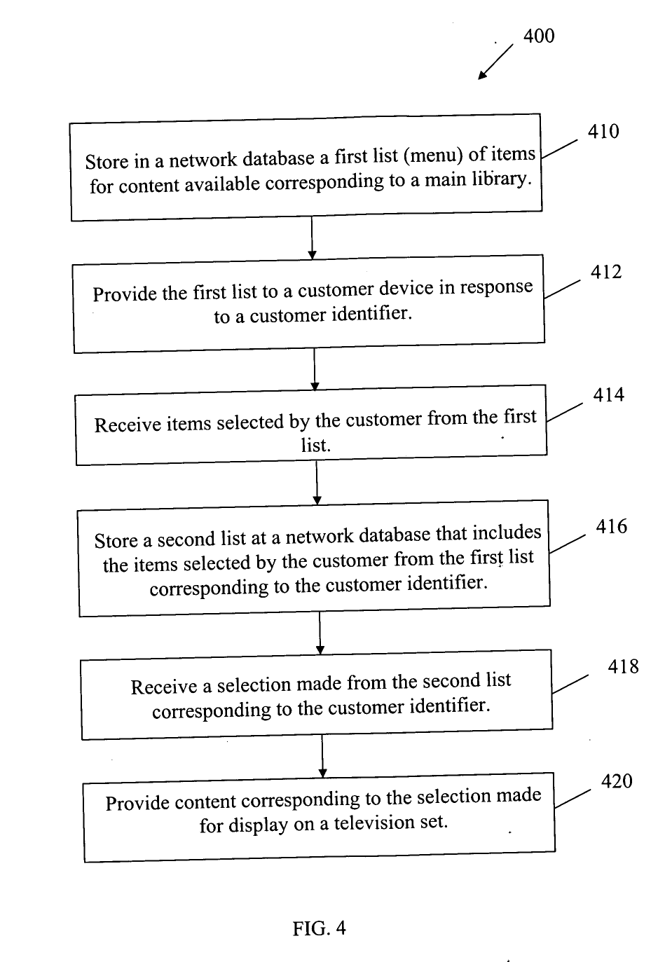

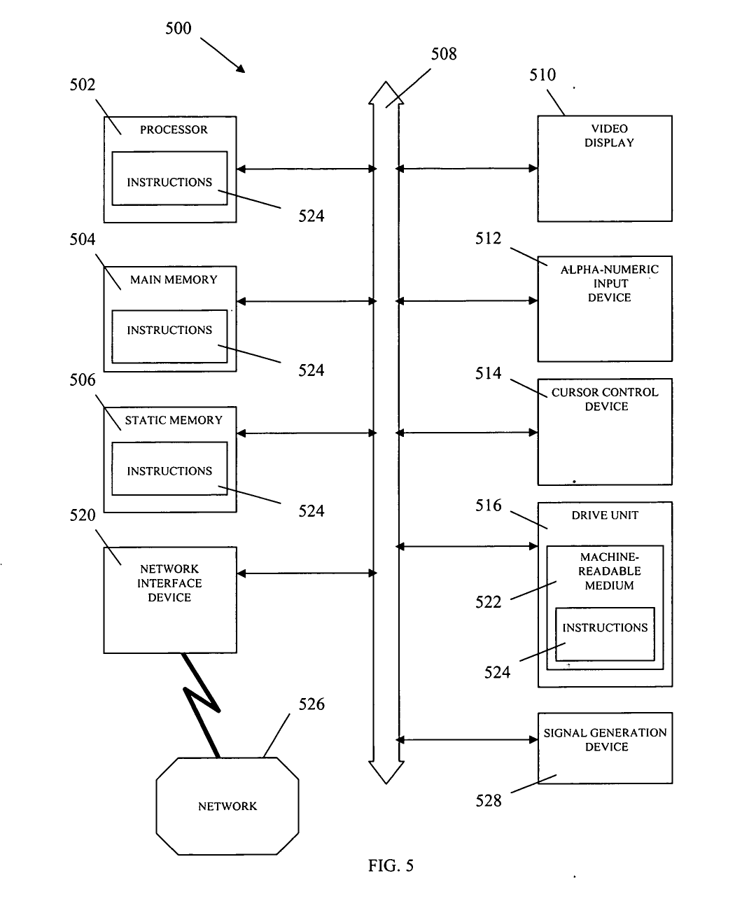

FIG. 4 depicts a flowchart of an exemplary method 400 according to one aspect of the present disclosure. As shown in box 410, a first list or menu of items is stored in a network database (video, audio, data) corresponding to a main library of content that is available to customers over a television network. The method provides the first list for display on a customer device, such as computer, PDA, STB, etc., in response to a customer identifier, as shown box 412. Upon receiving input for items selected by the customer from the first list (box 414), the selected items are stored in a second list at the network database as a personal library corresponding to the customer identifier (box 416). Upon receiving a request to provide content for any of the items in the personal library (box 418), the content is delivered to a customer device for display on a television set (box 420). If a charge is associated with the delivered of the content, it is recorded corresponding to the customer identifier. The methods and processes described herein may be implemented on a computer system, such as described below in reference to FIG. 5.

FIG. 5 is a diagrammatic representation of a machine in the form of a computer system within which a set of instructions, when executed, may cause the machine to perform any one or more of the methodologies of the present disclosure. FIG. 5 is a diagrammatic representation of a machine in the form of a computer system 500 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

What is claimed is:

1. A computer-readable medium accessible to a processor for executing instructions contained in a computer program embedded in the computer-readable medium, the computer program comprising:
instructions to provide to a user device a first list of items that corresponds to content stored in a first database over a communications network;
instructions to store a second list of items selected from the first list of items in a second database associated with the communications network corresponding to a user identifier;
instructions to retrieve content from the first database that corresponds to an item selected from the second list of items; and
instructions to provide the retrieved content over the communications network for display.

2. The computer-readable medium of claim 1, wherein the instructions to provide the retrieved content further comprise instructions to provide the content in response to an input from a set-top-box for display on a television set.

3. The computer-readable medium of claim 1, wherein the user device is one of a: a set-top-box; a computer; and a wireless device.

4. The computer-readable medium of claim 1, wherein the computer program further comprises:
instructions to provide attributes corresponding to the first or second list of items to the user device;
instructions to receive selection of an attribute from the provided attributes; and
instructions to search the first database for other content having the selected attribute.

5. The computer-readable medium of claim 4, wherein the computer program further comprises:
instructions to provide a third list of items that corresponds to the other content to the user device; and
instructions to update the second list in response to a selection made from the third list.

6. The computer-readable medium of claim 4, wherein the attributes include at least one of: title; artist, producer, director, author, language, subject, file, and document type.

7. A computer-readable medium accessible to a processor for executing instructions contained in a computer program embedded in the computer-readable medium, the computer program comprising:
instructions to receive a first command from a user corresponding to a user identifier, the command identifying content within a content database;
instructions to create a list corresponding to the identified content corresponding to the user identifier;
instructions to store the list in a second database at a communications network; and
instructions to provide content corresponding to an item selected from the list in response to a second command from the user for display on a user device.

8. The computer readable medium of claim 7, wherein the content includes at least one of: video, voice and data.

9. The computer readable medium of claim 8, wherein the first command is received from a remote device that is one of: a computer; a set-top-box; and a wireless device.

10. A method for providing television services, comprising:
providing a first list of items that corresponds to content stored in a first database over a communications network in response to a first input;
storing in a second database at the network a second list of items selected from the first list of items in response to a second input;
retrieving content from the first database corresponding to an item selected from the second list of items in response to a third input; and
providing the retrieved content over the communications network for display on a user device.

11. The method of claim 10, wherein the third input is received from a set-top-box associated with the user device.

12. The method of claim 11, wherein each of the first, second and third input is received from any one of: a set-top-box; a computer; and a wireless device.

13. The method of claim 10 further comprising:
providing attributes corresponding to the first list or second list of items;
receiving a selection of an attribute from the provided attributes; and
searching the first database for other content having the selected attribute.

14. The method of claim 13 further comprising:
updating the second list to include an item that corresponds to the other content; and
providing the other content to the user device in response to a fourth input.

15. A system for use in providing content over a communications network, comprising:
a database within the communications network that stores a separate identifier corresponding to each of a plurality of customers and a first list of items that corresponds to content of a main library;
a server having access to a computer program, the server utilizing the database and executing instructions contained in the computer program that includes:
instructions to provide the first list corresponding to each of the plurality of identifiers;
instructions to store in the database a separate list selected from the first list as a separate personal library corresponding to each of the separate identifiers; and
instructions to provide content relating to an item selected from any of the separate lists over the communications network for display on a user device.

16. The system of claim 15, wherein the computer program further comprises:
instructions to provide attributes corresponding to an item in the first list;
instructions to search for other content that corresponds to a selected attribute from the provided attributes; and
instructions to provide the other content in response to a selection made for the other content.

17. The system of claim 15, wherein the computer program further comprises instructions to verify the separate identifiers prior to providing any one of the first list and second list.

18. A communications network for providing content, comprising:
a backbone network that provides content to a user device over a communication line for display;
a database in the backbone network that stores content corresponding to a library;
at least one server associated with the backbone network that has access to the database; and
a computer program containing instructions that are executed by the at least one server to:
provide a first list of items corresponding to the library to the user device;
store a second list of items selected from the first list of items in response to a selection made from the user device; and
store the second list of items in the database corresponding to a user identifier.

19. The network of claim 18, wherein the server further executes instructions contained in the computer program to:
receive a selection from the second list; and
provide content corresponding to the selection to the user device.

20. The network of claim 19, wherein the backbone network includes servers and communication links that provide the content via one of using internet television protocol, over a wireless network, and over a cable network.

21. The communications network of claim 20, wherein the user device is one of a computer, wireless device, and set-top-box.
